(19) United States
(12) Patent Application Publication
(10) Pub. No.: US 2018/0275360 A1
(43) Pub. Date: Sep. 27, 2018

(54) OPTICAL COUPLING MODULE

(71) Applicant: KABUSHIKI KAISHA TOSHIBA, Tokyo (JP)

(72) Inventors: Hiroshi UEMURA, Yokohama Kanagawa (JP); Hideto FURUYAMA, Yokohama Kanagawa (JP); Yoichiro KURITA, Minato Tokyo (JP); Fumitaka ISHIBASHI, Kawasaki Kanagawa (JP)

(73) Assignee: KABUSHIKI KAISHA TOSHIBA, Tokyo (JP)

(21) Appl. No.: 15/696,943

(22) Filed: Sep. 6, 2017

(30) Foreign Application Priority Data
Mar. 22, 2017 (JP) 2017-056520

(51) Int. Cl. G02B 6/42

(52) U.S. Cl. CPC G02B 6/4243; G02B 6/4249; G02B 6/423; G02B 6/4245

(57) ABSTRACT

According to one embodiment, there is provided an optical coupling module including an optical device and an adaptor. The adaptor is attached to the optical device. The optical device has an optical element and a via. The optical element is placed on a first principal surface of a substrate. The via is placed in the substrate at a position corresponding to the optical element. The via has a first opening in a second principal surface of the substrate opposite to the first principal surface. The via does not reach the first principal surface. The adaptor has a guide hole having a second opening in a third principal surface of the adaptor opposite the second principal surface. The second opening corresponds to the first opening. The guide hole has a third opening in a fourth principal surface of the adaptor.

### CROSS-REFERENCE TO RELATED APPLICATIONS

This application is based upon and claims the benefit of priority from Japanese Patent Application No. 2017-056520, filed on Mar. 22, 2017; the entire contents of which are incorporated herein by reference.

### FIELD

Embodiments described herein relate generally to an optical coupling module.

### BACKGROUND

In configuring an optical communication system using optical fibers, optical coupling between optical fibers and optical elements is made. At this time, it is desired that the optical coupling be easy.

### BRIEF DESCRIPTION OF THE DRAWINGS

FIG. 1A is a plan view showing the configuration of an optical device in an embodiment;

FIGS. 1B and 1C are cross-sectional views showing the configuration of the optical device in the embodiment;

FIG. 2 is a perspective view showing the configuration of an optical coupling module according to the embodiment;

FIG. 3 is a cross-sectional view showing the configuration of the optical coupling module according to the embodiment;

FIG. 4 is a cross-sectional view showing the configuration of the optical coupling module according to the embodiment;

FIG. 5 is a plan view showing the configuration of the optical coupling module according to the embodiment;

FIGS. 6A and 6B are cross-sectional views showing the assembly of the optical coupling module according to the embodiment;

FIGS. 7A and 7B are cross-sectional views showing the assembly of the optical coupling module according to the embodiment;

FIG. 8 is a perspective view showing the configuration of an optical coupling module according to a modified example of the embodiment;

FIG. 9 is a cross-sectional view showing the configuration of the optical coupling module according to the modified example of the embodiment;

FIG. 10 is a cross-sectional view showing the configuration of the optical coupling module according to the modified example of the embodiment;

FIGS. 11A and 11B are cross-sectional views showing the assembly of the optical coupling module according to the modified example of the embodiment;

FIG. 12 is a perspective view showing the configuration of an optical coupling module according to another modified example of the embodiment;

FIG. 13 is a cross-sectional view showing the configuration of the optical coupling module according to the other modified example of the embodiment;

FIG. 14 is a cross-sectional view showing the configuration of the optical coupling module according to the other modified example of the embodiment;

FIGS. 15A and 15B are cross-sectional views showing the assembly of the optical coupling module according to the other modified example of the embodiment; and

FIGS. 16A and 16B are cross-sectional views showing the assembly of the optical coupling module according to the other modified example of the embodiment.

### DETAILED DESCRIPTION

In general, according to one embodiment, there is provided an optical coupling module including an optical device and an adaptor. The adaptor is attached to the optical device. The optical device has an optical element and a via. The optical element is placed on a first principal surface of a substrate. The via is placed in the substrate at a position corresponding to the optical element. The via has a first opening in a second principal surface of the substrate opposite to the first principal surface. The via does not reach the first principal surface. The adaptor has a guide hole having a second opening in a third principal surface of the adaptor opposite the second principal surface. The second opening corresponds to the first opening. The guide hole has a third opening in a fourth principal surface of the adaptor.

Exemplary embodiments of an optical coupling module will be explained below in detail with reference to the accompanying drawings. The present invention is not limited to the following embodiments.

### Embodiment

An optical coupling module according to an embodiment will be described. In an optical communication system using optical fibers, an electrical signal from a transmitting circuit is converted by an optical element (light-emitting element or light modulating element) into an optical signal, which is transmitted through an optical fiber and the like, and the optical signal transmitted through the optical fiber and the like is photoelectrically converted by an optical element (light-receiving element) into an electrical signal, which is transmitted to a receiving circuit. In order to configure the optical communication system so as to appropriately perform the transmission of the optical signal between the optical fiber and optical elements, optical coupling between the optical fiber and optical elements is made. In the optical coupling, the optical axis of the optical fiber and the optical axis of the optical element need to be highly accurately aligned with each other. In this case, it would often increase production cost to align the optical fiber with the optical element while measuring the intensities of the optical signal and of the electrical signal.

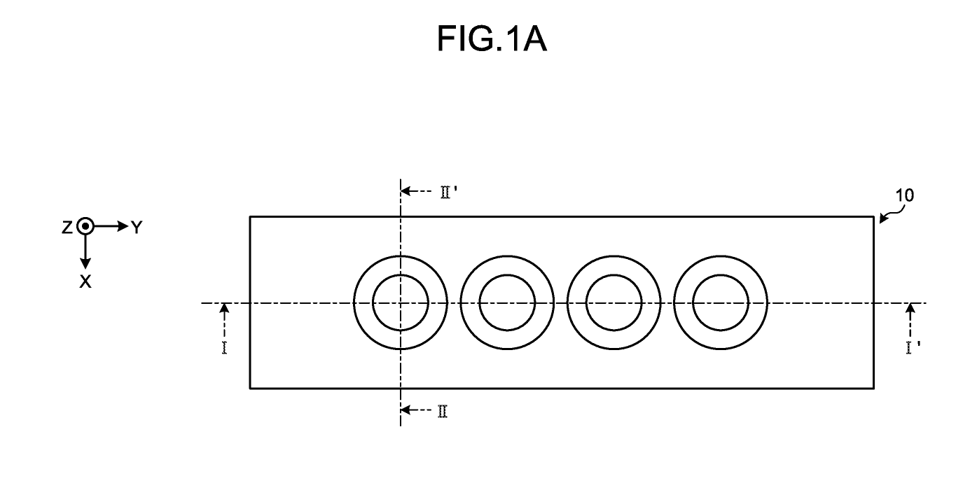

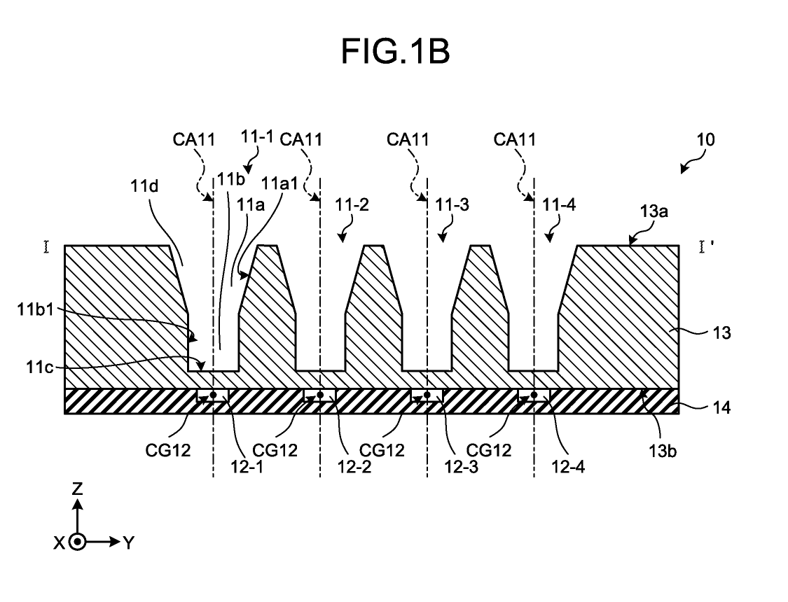

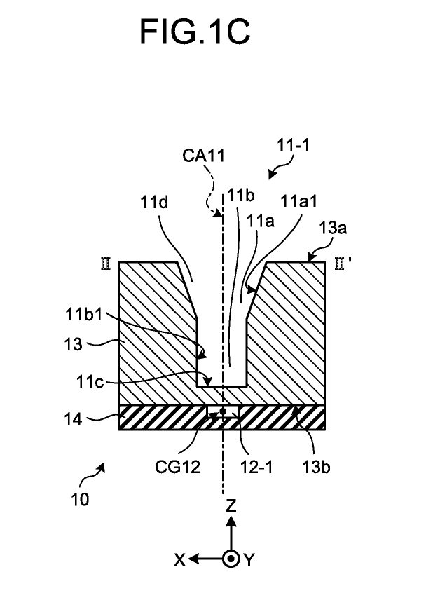

In contrast, using an optical device where the center axis of a via and the center of an optical element are highly accurately aligned with each other beforehand, simply by inserting an optical fiber into that via, the optical axis of the optical fiber and that of the optical element can be highly accurately aligned with each other. For example, an optical device 10 has a substrate 13, a plurality of optical elements 12-1 to 12-4, and an insulation layer 14 as shown in FIGS. 1A to 1C. In the substrate 13, a plurality of vias 11-1 to 11-4 are arranged. FIG. 1A is a plan view showing the configuration of the optical device 10. FIGS. 1B and 1C are cross-sectional views showing the configuration of the optical device 10. FIG. 1B is a cross-sectional view taken along line I-I′ of FIG. 1A, and FIG. 1C is a cross-sectional view taken along line II-II′ of FIG. 1A. In FIGS. 1A to 1C, let the Z direction be a direction perpendicular to a principal surface 13a and the X and Y directions be two directions orthogonal to each other in a plane perpendicular to the Z direction.

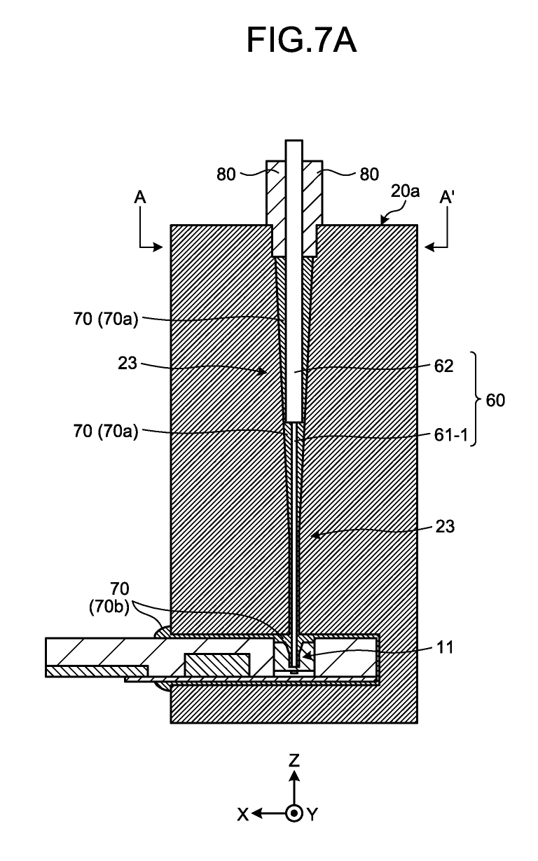

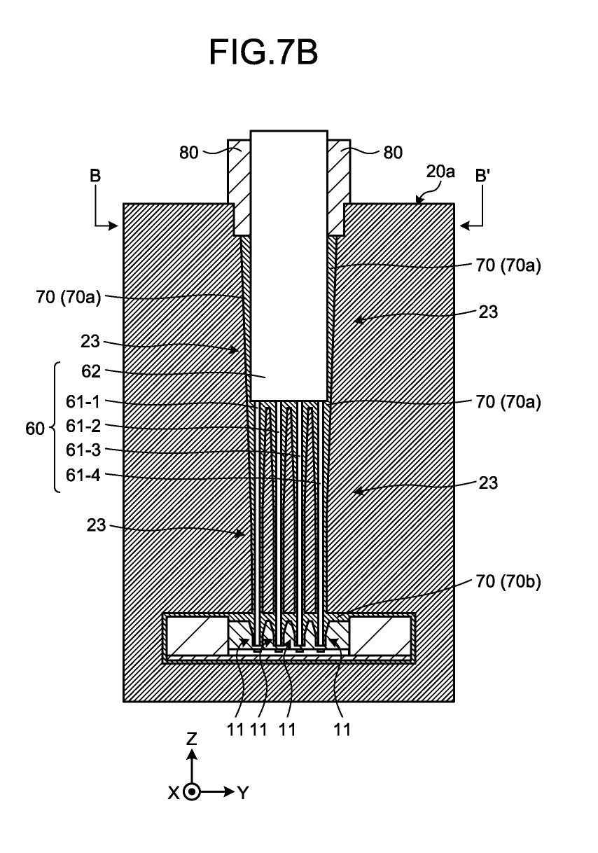

The substrate 13 can be shaped substantially like a rectangular parallelepiped corresponding to the arrangement of multiple optical fibers (see FIG. 7B). The substrate 13 can be formed of material consisting mainly of a semiconductor such as silicon. The substrate 13 has a principal surface (first principal surface) 13b and the principal surface (second principal surface) 13a. The principal surface 13a is a surface opposite to the principal surface 13b of the substrate 13. The wavelength of light used in optical communication via optical fibers is a wavelength to which the substrate 13 is transparent (that is, a wavelength at which the optical transmittance of the substrate 13 is greater than or equal to a reference level).

The plurality of optical elements 12-1 to 12-4 are arranged on the principal surface 13b of the substrate 13. The optical elements 12 are formed on the principal surface 13b of the substrate 13 by providing a crystal-grown layer, grown on a compound semiconductor substrate, directly on the principal surface 13b or bonding the crystal-grown layer to the principal surface 13b via an adhesive or the like. The optical elements 12 can include, e.g., a light-emitting element, a light modulating element, or a light-receiving element. Each optical element 12 is formed of such a material that the optical element 12 functions as a light-emitting element, a light modulating element, or a light-receiving element at light wavelengths to which the substrate 13 is transparent.

If the substrate 13 is formed of material consisting mainly of silicon, and the optical elements 12 are light-emitting elements, then each optical element 12 can be formed of material consisting mainly of a compound semiconductor or an organic semiconductor. Each optical element 12 may be formed of, e.g., material consisting mainly of a GaInAsP-based or AlInGaAs-based substance lattice-matched to an InP substrate, and in this case, the emission wavelength of the optical element 12 (a light-emitting element) can be made longer than, e.g., 1.3 μm. Further, the substrate 13 may be formed of material consisting mainly of gallium arsenic, gallium nitride, sapphire, or the like. In this case, each optical element 12 may be formed of an aluminum-gallium-arsenic-based material or an aluminum-gallium-indium-nitride-based material, and the emission wavelength of the optical element 12 (a light-emitting element) can be made longer than, e.g., 0.85 μm or 0.4 μm.

If the substrate 13 is formed of material consisting mainly of silicon, and the optical elements 12 are light-receiving elements, then each optical element 12 can be formed of material consisting mainly of a compound semiconductor or an organic semiconductor. Each optical element 12 may be formed of, e.g., material consisting mainly of a GaInAs-based substance lattice-matched to an InP substrate. In this case, the optical element 12 (a light-receiving element) can receive light having wavelengths longer than, e.g., 1.3 μm. Further, the substrate 13 may be formed of material consisting mainly of gallium arsenic, gallium nitride, sapphire, or the like. In this case, each optical element 12 may be formed of a gallium-indium-arsenic-based material or a gallium-indium-nitride-based material, and the optical element 12 (a light-receiving element) can receive light having wavelengths longer than, e.g., 0.85 μm or 0.4 μm.

The insulation layer 14 is placed on the principal surface 13b side of the substrate 13 to cover the principal surface 13b of the substrate 13 and the optical elements 12. The insulation layer 14 can be formed of material consisting mainly of an insulator such as silicon oxide.

The plurality of vias 11-1 to 11-4 are placed in the substrate 13 at positions corresponding to the plurality of optical elements 12-1 to 12-4. The center axis CA11 of the via 11-1 extends substantially in the Z direction to run through a point near the center CG12 of the optical element 12-1. The center axis CA11 of the via 11-2 extends substantially in the Z direction to run through a point near the center CG12 of the optical element 12-2. The center axis CA11 of the via 11-3 extends substantially in the Z direction to run through a point near the center CG12 of the optical element 12-3. The center axis CA11 of the via 11-4 extends substantially in the Z direction to run through a point near the center CG12 of the optical element 12-4. That is, the optical device 10 is configured such that, by inserting an optical fiber into the via 11, the optical axis of the optical fiber and that of the optical element 12 can be highly accurately aligned with each other.

Each via 11 has an opening (first opening) 11d in the principal surface 13a of the substrate 13 and has a bottom 11c on the principal surface 13b side of the substrate 13. Each via 11 extends from the opening 11d through the substrate 13 toward the principal surface 13b but not reaching the principal surface 13b. The depth along the Z direction of each via 11 is smaller than the thickness along the Z direction of the substrate 13. The bottom 11c of each via 11 extends along the principal surface 13b (along the X and Y directions) on the principal surface 13a side of the principal surface 13b.

Each via 11 has portions 11a and 11b. The portion 11a of each via 11 is placed on the principal surface 13a side, and the portion 11b is placed on the principal surface 13b side.

The maximum width on the principal surface 13a side of the portion 11a is wider than the maximum width on the principal surface 13b side thereof. The portion 11a is surrounded by an inner side surface 11a1 to be substantially in an inverted truncated cone shape. The inner side surface 11a1 extends at an angle to the Z direction and runs farther away from the center axis CA11 when going in the +Z direction.

The maximum width on the principal surface 13b side of the portion 11b can be made the same as the maximum width on the principal surface 13a side thereof. The portion 11b is surrounded by the bottom 11c and an inner side surface 11b1 to be substantially in a cylinder shape. The inner side surface 11b1 extends along the Z direction. For example, the minimum width of the portion 11b and the minimum width on the bottom 11c side can be made equal to the maximum diameter of a core line (core plus clad) plus a margin. Accordingly, each of the maximum width on the opening 11d side of the portion 11b and the maximum width on the bottom 11c side thereof can be made to be a size corresponding to the width of the other part (core plus clad) than the covering of an optical fiber.

Accordingly, correspondingly to the maximum width of the portion 11b, the optical device 10 is configured such that, e.g., the external dimension thereof along the X direction is about six to eight times the maximum width of the portion 11b and that the external dimension along the Y direction is about two to three times the maximum width of the portion 11b. Thus, an increase in the material cost of the optical device 10 can be suppressed.

Consider mounting where an optical fiber is inserted into the via 11 of the optical device 10 to be optically coupled to the optical element 12. Because the external dimensions of the optical device 10 are small correspondingly to the width of the core line (core plus clad) other than the covering of the optical fiber, the optical device 10 may be difficult to hold. Further, because the maximum width on the opening 11d side of each via 11 is small correspondingly to the width of the core line (core plus clad) other than the covering of the optical fiber, it may be difficult to insert the optical fiber into the via 11 of the optical device 10.

Accordingly, in the present embodiment, an adaptor 20 is attached to the optical device 10, and by providing in the adaptor 20 a guide hole 23 to guide optical fibers into the vias 11 of the optical device 10, the mounting of optical fibers is facilitated. The optical device 10 may be covered by the adaptor 20.

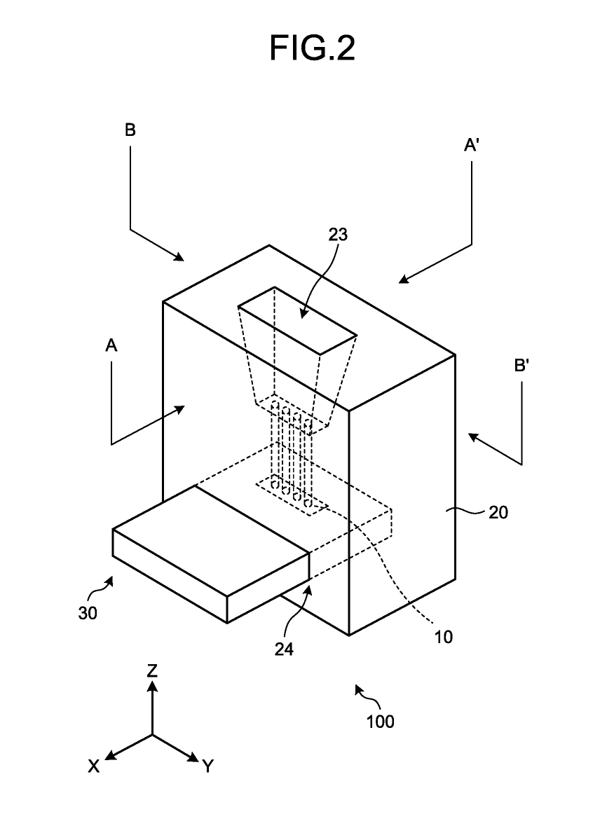

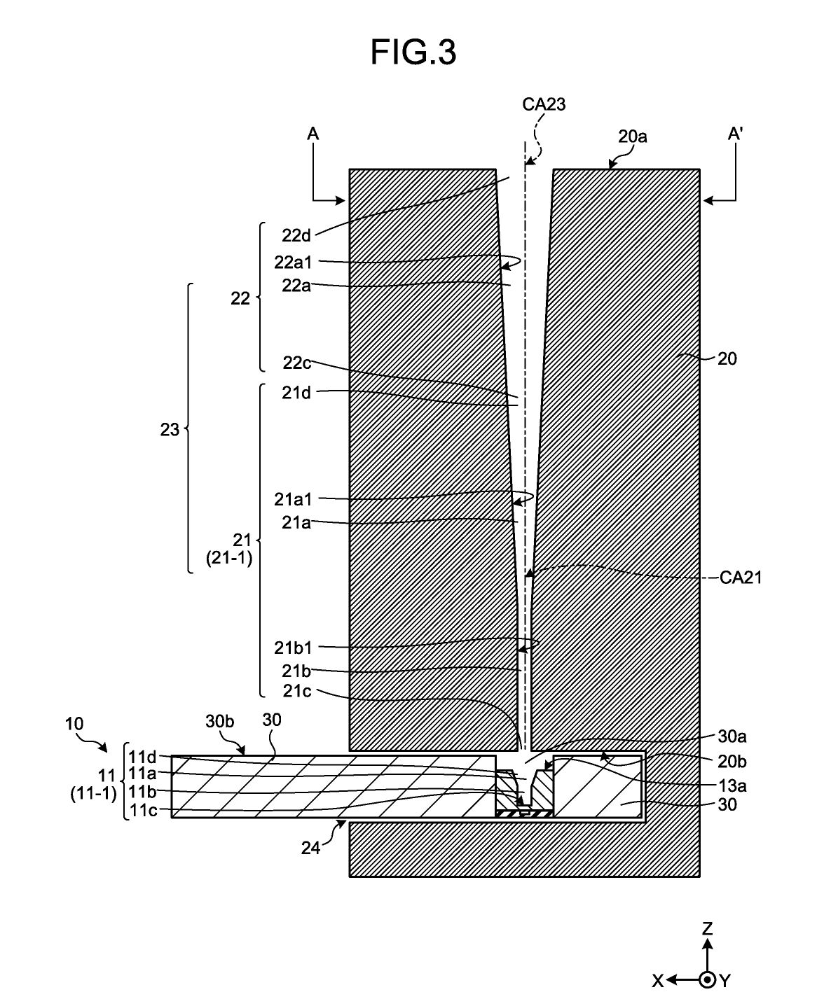

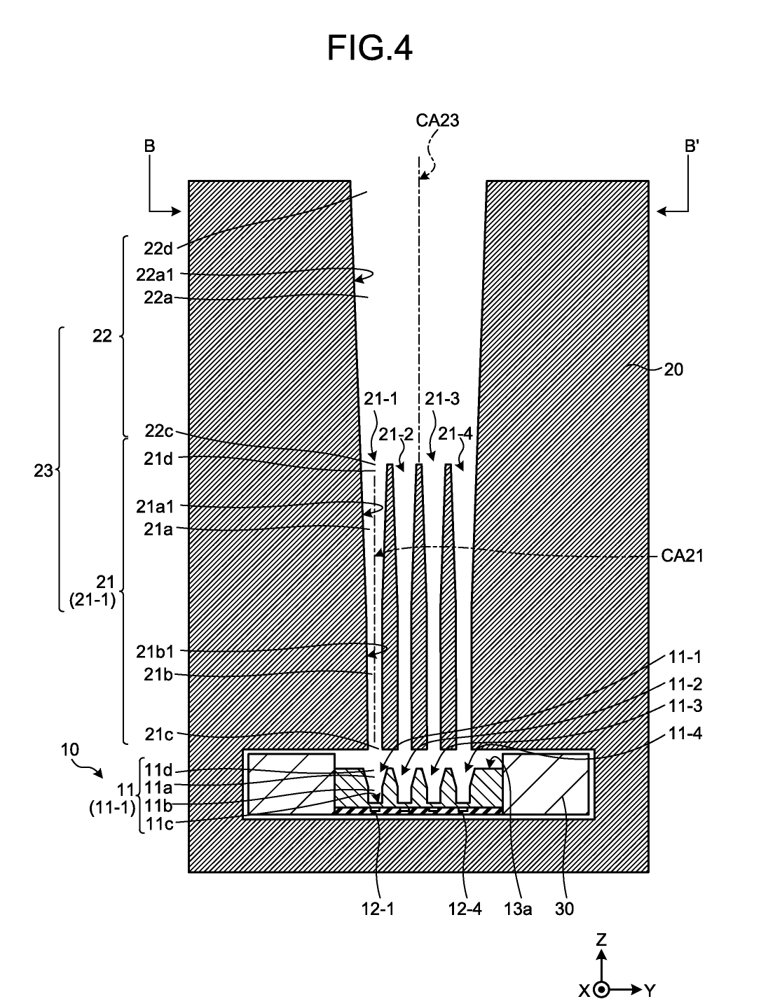

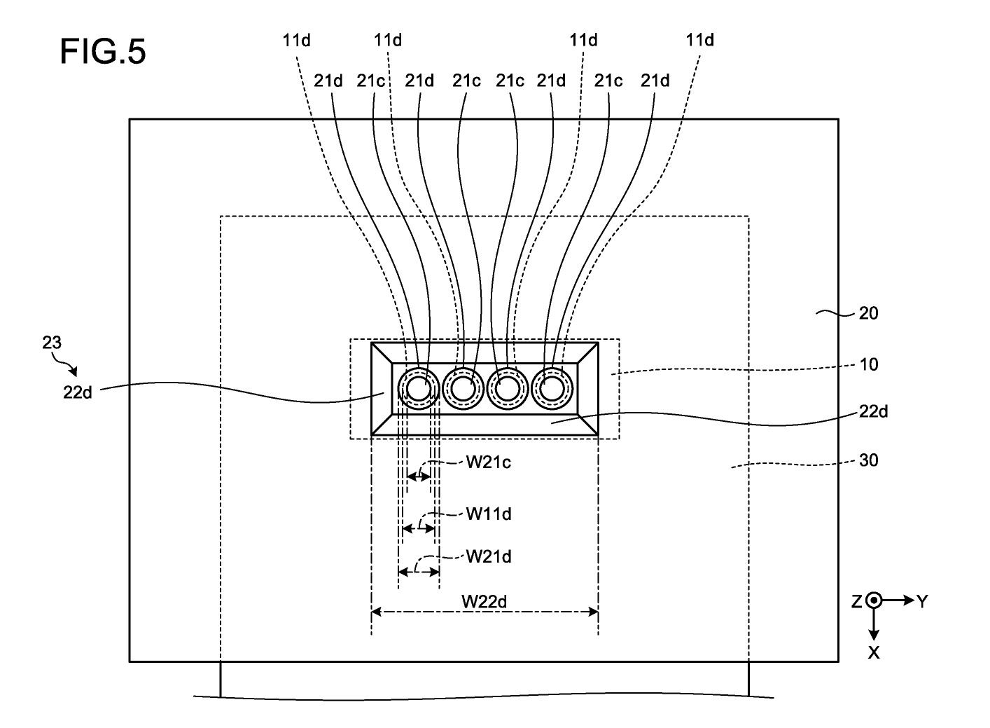

An optical coupling module 100 including the optical device 10 can be configured as shown in, e.g., FIGS. 2 to 5. FIG. 2 is a perspective view showing the configuration of the optical coupling module 100. FIG. 3 is a cross-sectional view showing the configuration of the optical coupling module 100 and is a cross-sectional view of the optical coupling module 100 taken along line A-A′ of FIG. 2. FIG. 4 is a cross-sectional view showing the configuration of the optical coupling module 100 and is a cross-sectional view of the optical coupling module 100 taken along line B-B′ of FIG. 2. FIG. 5 is a plan view showing the configuration of the optical coupling module 100

The optical coupling module 100 has the optical device 10, the adaptor 20, and a substrate 30. The optical device 10 may be fitted into an opening 30a in the substrate 30 so as to be mounted in the substrate 30 (see FIG. 3) or may be placed on a principal surface 30b of the substrate 30 so as to be mounted on the substrate 30.

The adaptor 20 has such external dimensions as to be easy to hold. The adaptor 20 can be formed of material having stiffness and elasticity suitable to be held and which is easy to mold. The adaptor 20 can be formed of material consisting mainly of, e.g., elastomer resin, liquid crystal resin, PPS (polyphenylene sulfide), epoxy resin, or the like.

The maximum width of the adaptor 20 is greater than the maximum width of the optical device 10. The adaptor 20 is configured in such a way as to, e.g., cover the optical device 10 when the optical device 10 is mounted therein. The adaptor 20 has the guide hole 23 and a recess 24. The recess 24 extends primarily along an XY plane. The recess 24 is formed to accommodate the optical device 10 and the substrate 30. The adaptor 20 covers the optical device 10 while the optical device 10 and the substrate 30 are accommodated in the recess 24. The guide hole 23 is placed to be in communication with the vias 11 of the optical device 10 while the optical device 10 and the substrate 30 are accommodated in the recess 24. Thus, the guide hole 23 can be easily aligned with the vias 11.

The guide hole 23 is placed in a position corresponding to the plurality of optical elements 12-1 to 12-4 on the substrate 13 (see FIG. 1). The center axis CA23 of the guide hole 23 extends along a direction substantially perpendicular to the principal surface 30b of the substrate 30, that is, the Z direction. The guide hole 23 has a plurality of openings (second openings) 21c in a principal surface 20b (a third principal surface) of the adaptor 20 and an opening (third opening) 22d in a principal surface 20a of the adaptor 20. The principal surface 20b is a principal surface of the adaptor 20 opposite the principal surface 13a of the optical device 10 and is an inner side surface of the recess 24. The principal surface 20a is a principal surface on the +Z side of the adaptor 20. When seen through from the +Z direction, the opening 22d contains the plurality of openings 21c (see FIG. 5).

The guide hole 23 has a second hole 22 and a plurality of first holes 21-1 to 21-4. The second hole 22 is in communication with the plurality of first holes 21-1 to 21-4. Each of the first holes 21-1 to 21-4 is in communication with the space inside the recess 24. The center axis CA21 of the first hole 21-1 to 21-4 extends through a point near the center CG12 of the optical element 12-1 to 12-4 (see FIG. 4).

The second hole 22 has the opening (third opening) 22d in the principal surface (fourth principal surface) 20a on the +Z side of the adaptor 20 and an opening 22c on the −Z side. The second hole 22 extends from the opening 22d through the adaptor 20 along the −Z direction to reach the opening 22c. The opening 22c is in communication with the plurality of first holes 21-1 to 21-4.

The maximum width on the principal surface 20a side of the second hole 22 is wider than the maximum width on the principal surface 20b side thereof. The second hole 22 is surrounded by an inner side surface 22a1 to be substantially in an inverted truncated square pyramid shape. The inner side surface 22a1 extends at an angle to the Z direction and runs farther away from the center axis CA23 when going in the +Z direction.

Each first hole 21 has an opening 21d on the +Z side and an opening 21c in the principal surface 20b of the adaptor 20. Each first hole 21 extends from the opening 21d through the adaptor 20 along the −Z direction to reach the opening 21c. When seen through from the +Z direction, a plurality of the openings 21d are within the opening 22d, and a plurality of the openings 21c are within the opening 22d (see FIG. 5).

Each first hole 21 corresponds to a via 11 of the optical device 10. When seen through from the +Z direction, the opening 21c of each first hole 21 is within the opening 11d of the corresponding via 11 and may substantially coincide with the bottom 11c or contain the bottom 11c (see FIG. 5). Thus, when an optical fiber is inserted into the guide hole 23, the other part (core plus clad) than the covering of the optical fiber can be easily guided into a via 11.

Each first hole 21 has portions 21a and 21b. The portion 21a of each first hole 21 is placed on the principal surface 20a side, and the portion 21b is placed on the principal surface 20b side.

The maximum width on the principal surface 20a side of the portion 21a is wider than the maximum width on the principal surface 20b side thereof. The portion 21a is surrounded by an inner side surface 21a1 to be substantially in an inverted truncated cone shape. The inner side surface 21a1 extends at an angle to the Z direction and runs farther away from the center axis CA21 when going in the +Z direction.

The maximum width on the principal surface 20b side of the portion 21b can be made the same as the maximum width on the principal surface 20a side thereof. The portion 21b is surrounded by an inner side surface 21b1 to be substantially in a cylinder shape. The inner side surface 21b1 extends along the Z direction. Each of the maximum width on the opening 21d side of the portion 21b and the maximum width on the opening 21c side thereof can be made to be a size corresponding to the width of the other part (core plus clad) than the covering of an optical fiber.

As illustrated in FIG. 5, in the adaptor 20, the maximum opening width W22d of the opening 22d of the guide hole 23 is greater than the maximum opening width W21c of the opening 21c of the guide hole 23. The maximum opening width W21d of the opening 21d of the guide hole 23 is smaller than the maximum opening width W22d of the opening 22d and greater than the maximum opening width W21c of the opening 21c. The maximum opening width Wild of the opening 11d of the via 11 in the optical device 10 is greater than the maximum opening width W21c of the opening 21c of the guide hole 23 in the adaptor 20. It is desirable that the offset between the center of the opening 21c and the center of the opening 11d be smaller than (W11d−W21c)/2. That is, it is desirable that, when seen through from the +Z direction, the main part of the opening 11d be within the opening 21c. In this case, in FIG. 5, the opening 21c of the guide hole 23 is within the opening 11d of a via 11, so that an optical fiber can be easily inserted and that the tip of the optical fiber can be accurately guided (see FIG. 7).

Note that the maximum opening width Wild of the opening 11d of the via 11 may be greater than the maximum opening width W22d of the opening 22d of the guide hole 23. The maximum opening width W22d of the opening 22d can be regarded as the maximum width along a plane direction in an XY plane of the first hole 21. Although the bottom 11c of the via 11 in the optical device 10 is not shown in FIG. 5 for simplicity of illustration, the maximum width W11c of the bottom 11c of the via 11 may be substantially equal to or smaller than the maximum opening width W21c of the opening 21c of the guide hole 23.

Further, it is desirable that a gap be provided between the principal surface 13a of the optical device 10 and the principal surface 20b of the adaptor 20. The gap will provide a margin for an optical fiber becoming deformed to be inserted into the via 11 when there is an offset between the center of the opening 21c of the guide hole 23 in the adaptor 20 and the center of the opening 11d of the via 11 in the optical device 10. Or the end on the optical device 10 side and the neighboring part of the first hole 21 may be in an inverted tapered shape in which it is slightly gradually widened. Thus, a deformation margin can be secured as above. In this case, the end diameter of the first hole 21 can be defined by the minimum diameter before inversely tapered.

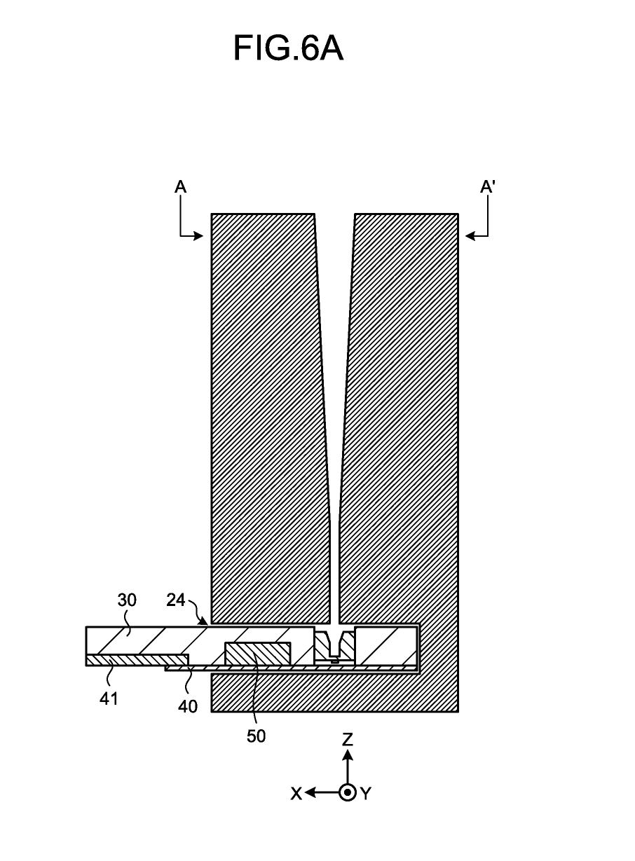

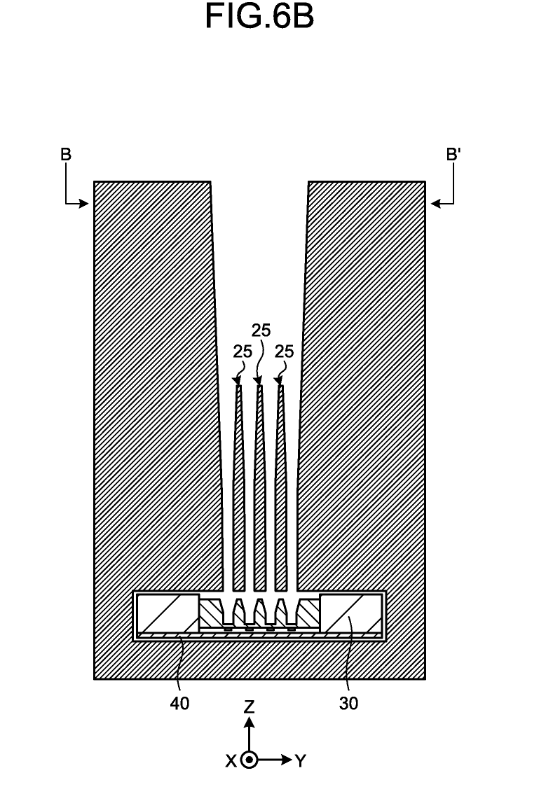

Next, the assembly of the optical coupling module 100 will be described illustratively using FIGS. 6A and 6B. FIGS. 6A and 6B are diagrams illustrating the assembly of the optical coupling module 100. FIG. 6A is a cross-sectional view corresponding to the cross-section taken along line A-A′ of FIG. 2, and FIG. 6B is a cross-sectional view corresponding to the cross-section taken along line B-B′ of FIG. 2.

In the assembly shown in FIGS. 6A and 6B, the optical coupling module 100 further has an interconnection 40, an electrode 41, and an IC 50. The interconnection 40 electrically connects the optical element 12 and the IC 50 in the optical device 10. The electrode 41 is electrically connected to the optical element 12 and the IC 50 via the interconnection 40. For example, the substrate 30 is a multi-layer printed wiring board and can be 2.0 mm thick. Or the substrate 30 may be a molded resin in which the optical element 12 and the IC 50 are embedded and integrated. The IC 50 can include, e.g., a RAID controller. The interconnection 40 and electrode 41 can be formed of material consisting mainly of, e.g., Cu.

An electrical signal outputted from the IC 50 can be converted by the optical element 12 (a light-emitting element or light modulating element) into an optical signal, or an optical signal can be converted by the optical element (a light-receiving element) into an electrical signal to be inputted to the IC 50. Thus, the optical coupling module 100 can be used as an optical coupling interface for transmitting/receiving an optical signal through an optical fiber. Signal transmission of higher speed, a longer distance, and lower noise is possible by an optical signal than by an electrical signal. For example, the optical coupling module 100 can be applied to a storage interface. The optical coupling module 100 facilitates optical fiber connection with the vias 11 having a small diameter (of, e.g., 127 μm) of the optical elements 12, and, without need for a complex device, yield can be improved reducing cost. And highly reliable optical coupling can be realized.

The assembly of the optical coupling module 100 in which further an optical fiber 60 is inserted into the assembly shown in FIGS. 6A and 6B will be described illustratively using FIGS. 7A and 7B. FIGS. 7A and 7B are diagrams illustrating the assembly of the optical coupling module 100. FIG. 7A is a cross-sectional view corresponding to the cross-section taken along line A-A′ of FIG. 2, and FIG. 7B is a cross-sectional view corresponding to the cross-section taken along line B-B′ of FIG. 2.

In the assembly shown in FIGS. 7A and 7B, the optical coupling module 100 further has the optical fiber 60 and an adhesive 70. That is, in the optical coupling module 100, the optical fiber 60 is inserted into the guide hole 23 of the adaptor 20 and fixed by the adhesive 70. The optical fiber 60 may be of a single-mode (SM) type or of a multi-mode type. If being of a multi-mode type, the optical fiber 60 may be of a graded-index (GI) type or of a step-index type.

The optical fiber 60 has a plurality of core lines 61-1 to 61-4 and a covering member 62. In the optical fiber 60, the plurality of core lines 61-1 to 61-4 are arranged at predetermined pitches, and their major parts are covered by the covering member 62. In the optical fiber 60, the tip side (tip) of each core line 61 is exposed with part of the covering member 62 being removed (not covered by the covering member 62). The number of vias 11 of the optical device 10 and the number of first holes 21 of the adaptor 20 are determined according to the number of core lines 61 of the optical fiber 60. The arrangement pitch of the vias 11-1 to 11-4 in the optical device 10 and the arrangement pitch of the first holes 21-1 to 21-4 in the adaptor 20 are determined according to the predetermined pitch. Each core line 61 has a core and a clad. Note that the number of vias 11 in the optical device 10 and the number of first holes 21 in the adaptor 20 may be greater than the number of core lines 61 of the optical fiber 60.

For example, each core line 61 has a core diameter of 50 μm and a clad diameter of 125 μm. The optical fiber 60 can be configured to have the four core lines 61-1 to 61-4 arranged at 250 μm pitches and covered by the covering member 62 as an integrated ribbon fiber. At the tip of each core line 61, a bare fiber is exposed with part of the covering member 62 being removed. The tip of each core line 61 is cleaved or cut by laser, and the core line 61 is inserted into a via 11 of the optical device 10 through the guide hole 23 of the adaptor 20. Thus, optical coupling between the core lines 61 of the optical fiber 60 and the optical elements 12 of the optical device 10 can be easily realized.

In the assembly shown in FIGS. 7A and 7B, the optical coupling module 100 may further have a buffer member 80. The buffer member 80 is placed at the end on the principal surface 20a side (the top of the drawing) of the guide hole 23. That is, the buffer member 80 is placed between the adaptor 20 and the optical fiber 60 in the opening 22d (see FIGS. 3, 4). The buffer member 80 can be formed of an elastic body such as rubber. Thus, when the optical fiber 60 inserted into the vias 11 through the guide hole 23 is bent, the optical fiber 60 can be prevented from being damaged at or near its part fixed by the adhesive 70.

As the adhesive 70 for adhesively fixing the optical fiber 60 to the guide hole 23 of the adaptor 20, the same kind of adhesive may be used over the area from the guide hole 23 to the vias 11, or different kinds of adhesives may be used respectively for the guide hole 23 and the vias 11. Or the adhesive 70 may be selectively used for the guide hole 23 without using the adhesive for the vias 11. In either case, it is desirable that the vias 11 with the tips of the core lines 61 of the optical fiber 60 therein are filled with the adhesive 70 or optical resin substantially transparent to the wavelength band in use. Thus, light reflection at the end face of each core line 61 of the optical fiber 60 and at the bottom 11c of the via 11 can be suppressed.

For example, an adhesive 70a such as epoxy resin is used for the guide hole 23 side, and optical resin 70b such as silicone resin substantially transparent to the wavelength band in use is used for the via 11 side so as not to fix. Thus, the damage of the optical element 12 due to the deformation (thermal expansion/bend) of the optical fiber 60 can be prevented. Further, by selecting a particular resin, cost and performance can be optimized. As the adhesive 70, a UV hardening, thermal hardening, or other resin can be used. For example, as the adhesive 70, an epoxy-based resin, an acryl-based resin, or another resin can be used.

Next, the method of assembling the optical coupling module 100 will be described using FIGS. 7A and 7B. For example, the adhesive 70 is supplied with use of a dispenser needle (not shown) to the inside of the recess 24 in the optical coupling module 100 shown in FIGS. 6A and 6B to coat with the adhesive 70. The substrate 30 in which the optical device 10 is mounted is inserted into the recess 24. Then the adhesive 70 is supplied with use of the dispenser needle (not shown) to the inside of the guide hole 23 and the insides of the vias 11 to coat with the adhesive 70. At this time, the adhesive 70b may be supplied with the dispenser needle to the insides of the vias 11, and the adhesive 70a may be supplied with the dispenser needle into the guide hole 23. Then, the optical fiber 60 is inserted, and the adhesive 70 is hardened.

When the optical fiber 60 is inserted, the optical fiber 60 should be inserted such that, e.g., the tip of the core line 61 abuts the bottom 11c of the via 11. Or stoppers 25 (see FIGS. 6A and 6B) for the covering member 62 are provided in the guide hole 23 of the adaptor 20, and the length of part of each core line 61 exposed outside the covering member 62 is made even, and the optical fiber 60 should be inserted such that the covering member 62 abuts the stoppers (stopper structures) 25. The stoppers 25 can be provided such that the core line 61 protrudes from the principal surface 20b (see FIG. 3) into the optical device 10 side over a length corresponding to the depth of the via 11 while the covering member 62 abuts the stoppers 25. Or the optical fiber 60 may be inserted into the adaptor 20 down to a predetermined depth in the via 11 using a dedicated jig or the like.

As described above, in the embodiment, in the optical coupling module 100, the adaptor 20 is attached to the optical device 10, and the guide hole 23 to guide the optical fiber 60 into the vias 11 of the optical device 10 is provided in the adaptor 20. That is, the maximum width of the adaptor 20 is greater than the maximum width of the optical device 10. Thus, if the external dimensions of the optical device 10 are small correspondingly to the width of the core line (core plus clad) 61 other than the covering member 62 of the optical fiber 60, the optical device 10 can be easily held via the adaptor 20. The opening 21c of the guide hole 23 corresponds to the opening 11d of a via 11. Thus, if the maximum width on the opening 11d side of each via 11 is small correspondingly to the width of the core line (core plus clad) 61 other than the covering member 62 of the optical fiber 60, the guide hole 23 can guide the core lines 61 into the vias 11, so that the optical fiber 60 can be easily inserted into the vias 11 of the optical device 10. Therefore, the mounting of the optical fiber 60 can be facilitated.

Further, in the embodiment, in the optical coupling module 100, the maximum opening width of the opening 21c of the guide hole 23 is smaller than the maximum opening width of the opening 11d of the via 11. Thus, the optical fiber 60 can be easily inserted into the vias 11 of the optical device 10.

Yet further, in the embodiment, in the guide hole 23, the maximum opening width of the opening 22d on the principal surface 20a side is greater than the maximum opening width of the opening 21c on the principal surface 20b side. Thus, the optical fiber 60 can be easily inserted into the guide hole 23.

Further, in the embodiment, the adaptor 20 has the recess 24 to accommodate the optical device 10. Thus, the guide hole 23 of the adaptor 20 can be easily aligned with the vias 11 of the optical device 10.

Yet further, in the embodiment, if the optical coupling module 100 has the optical fiber 60 extending through the guide hole 23 to near the bottoms 11c of the vias 11, the buffer member 80 can be placed between the adaptor 20 and the optical fiber 60 in the opening 22d. Thus, when the optical fiber 60 is pulled or bent, stress applied at or near the fixed part of the optical fiber 60 can be reduced, so that the reliability of the optical coupling module 100 can be improved.

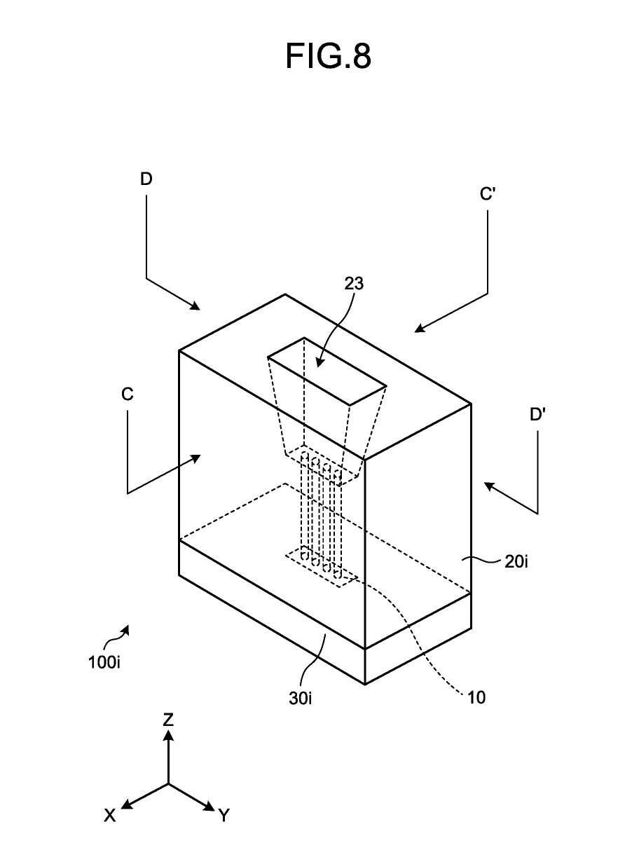

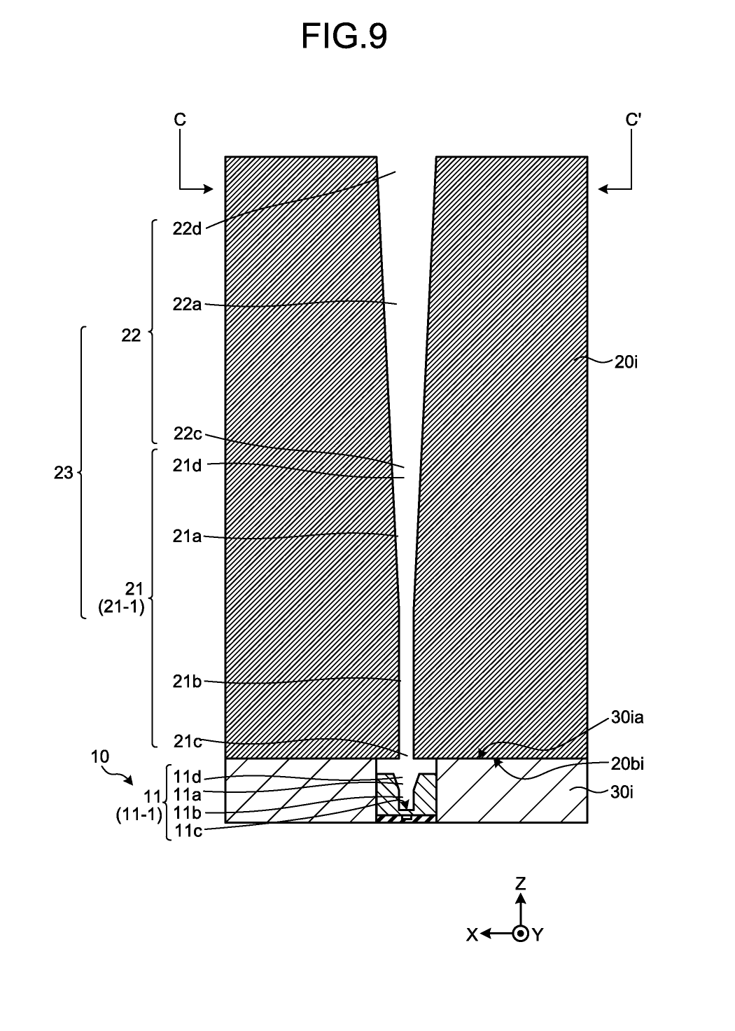

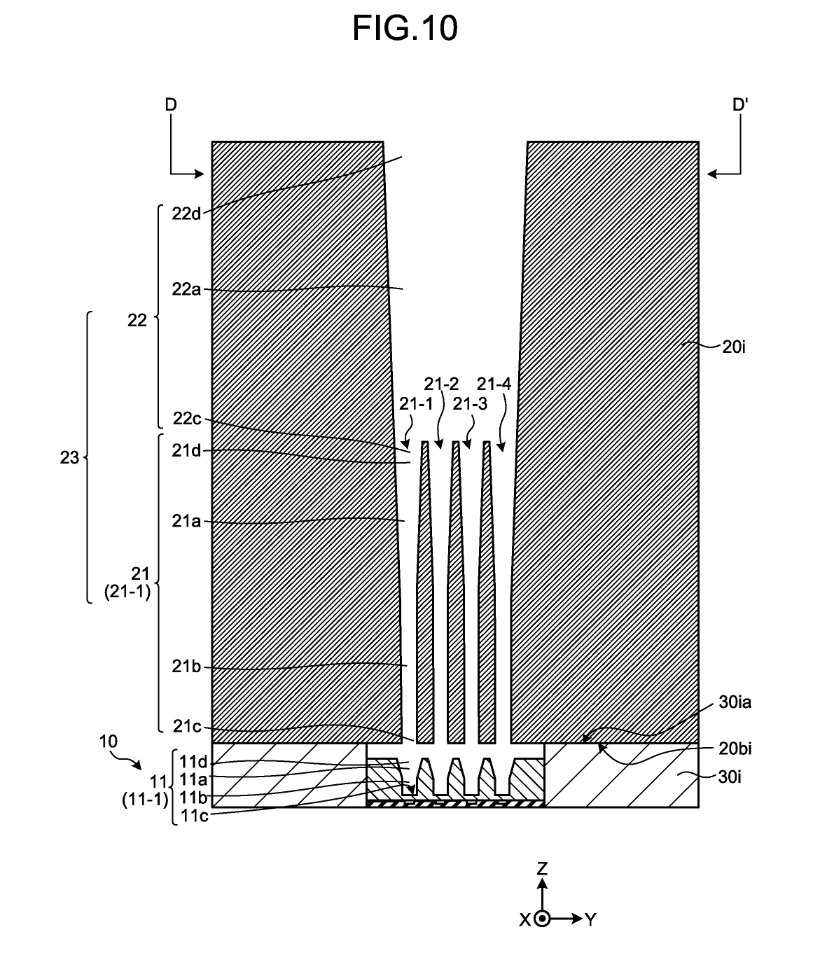

It should be noted that an adaptor 20i in an optical coupling module 100i may be configured not to have a recess to accommodate the optical device 10 as shown in FIGS. 8 to 10. FIG. 8 is a perspective view showing the configuration of the optical coupling module 100i according to a modified example of the embodiment. FIG. 9 is a cross-sectional view showing the configuration of the optical coupling module 100i according to the modified example of the embodiment and taken along line C-C′ of FIG. 8. FIG. 10 is a cross-sectional view showing the configuration of the optical coupling module 100i according to the modified example of the embodiment and taken along line D-D′ of FIG. 8.

Specifically, the adaptor 20i is substantially in a rectangular parallelepiped shape, and a substrate 30i has plan dimensions corresponding to the plan dimensions of the adaptor 20i. In the adaptor 20i, a principal surface 20bi opposite the optical device 10 forms an end face and can almost entirely touch a principal surface 30ia of the substrate 30i. The plan dimensions of the substrate 30i along plane directions in an XY plane may be smaller or greater than the plan dimensions of the adaptor 20i. Or the substrate 30i may be mounted on another substrate.

In this case, the same method as in the embodiment may be used for the method of mounting the optical fiber 60. That is, the optical device 10 is mounted in the substrate 30i, and after the adaptor 20i and the substrate 30i are aligned with each other with a dedicated jig or the like, the principal surface 30ia of the substrate 30i is bonded to the principal surface 20bi of the adaptor 20i. Then the guide hole 23 and the vias 11 may be coated with the adhesive 70, and the optical fiber 60 may be inserted into the vias 11 though the guide hole 23. In aligning the adaptor 20i with the substrate 30i, for example, a protrusion may be provided on the principal surface 20bi of the adaptor 20i and a recess may be provided in the principal surface 30ia of the substrate 30i so that the protrusion and recess are fitted together, thereby aligning them. Or, for example, a recess may be provided in the principal surface 20bi of the adaptor 20i and a recess may be provided in the principal surface 30ia of the substrate 30i so that, using a positioning pin (by inserting the positioning pin into the recess of the principal surface 20bi and the recess of the principal surface 30ia), the adaptor 20i is aligned with the substrate 30i.

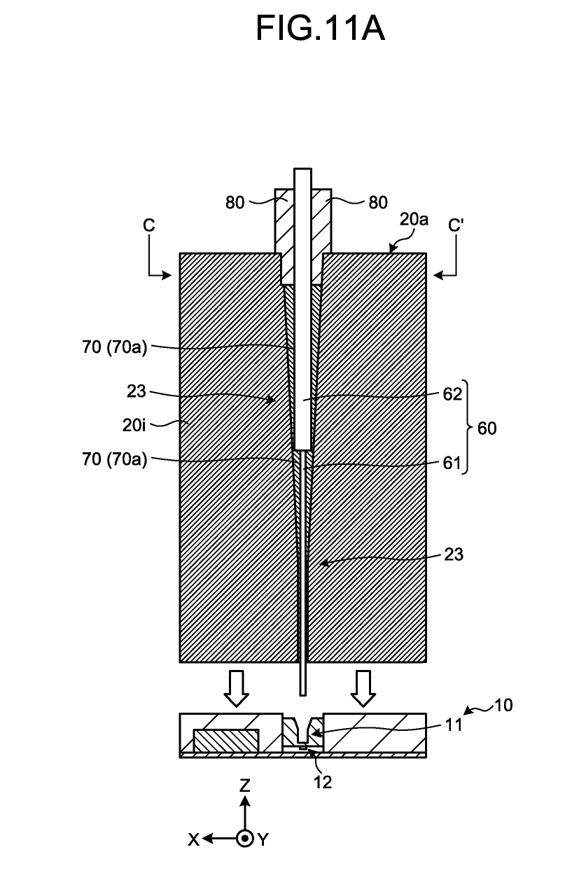

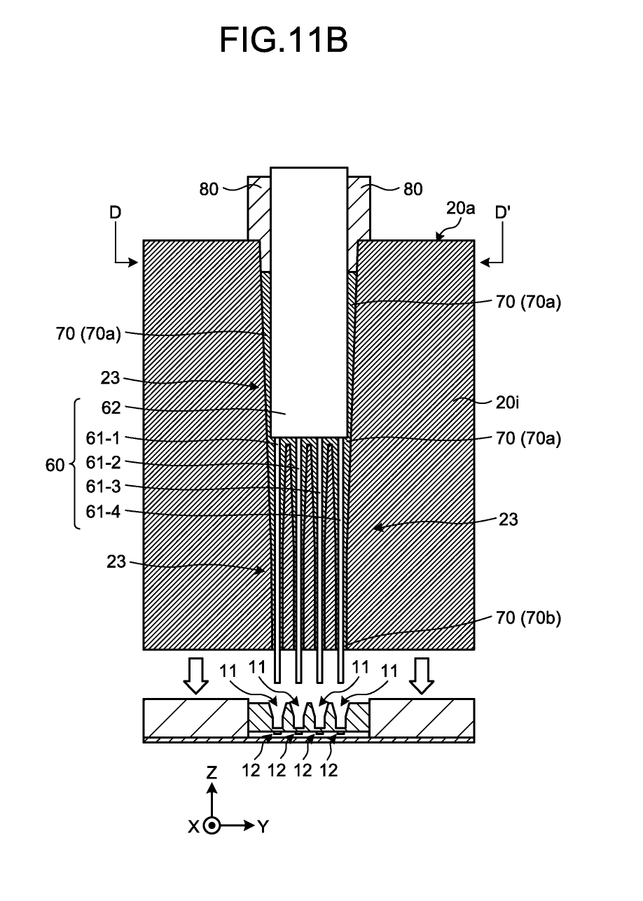

Or, as illustrated in FIGS. 11A and 11B, first, the adaptor 20i is fixed to the optical fiber 60 by the adhesive 70, and a member in which the adaptor 20i and the optical fiber 60 are integrated may be aligned with, attached to, and fixed to the optical elements 12 (vias 11). FIGS. 11A and 11B are diagrams illustrating the assembly of the optical coupling module 100i. FIG. 11A is a cross-sectional view corresponding to the cross-section taken along line C-C′ of FIG. 8, and FIG. 11B is a cross-sectional view corresponding to the cross-section taken along line D-D′ of FIG. 8. Thus, optical coupling between the core lines 61 of the optical fiber 60 and the optical elements 12 of the optical device 10 can be easily realized.

Although the embodiment and the above modified example describe embodiments wherein an optical fiber is supposed to be inserted in a direction substantially perpendicular to a principal surface of the substrate, an optical fiber may be desired to be inserted in a direction along a principal surface of the substrate.

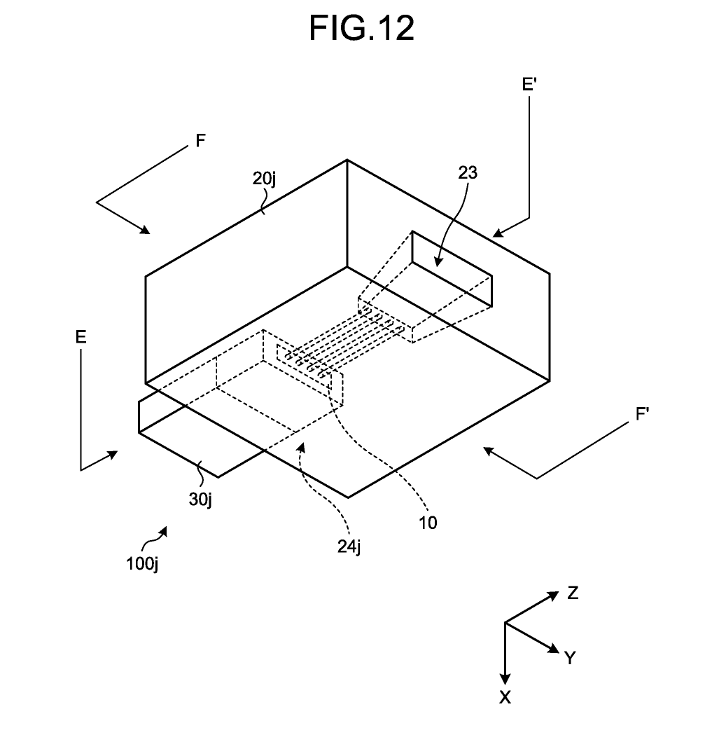

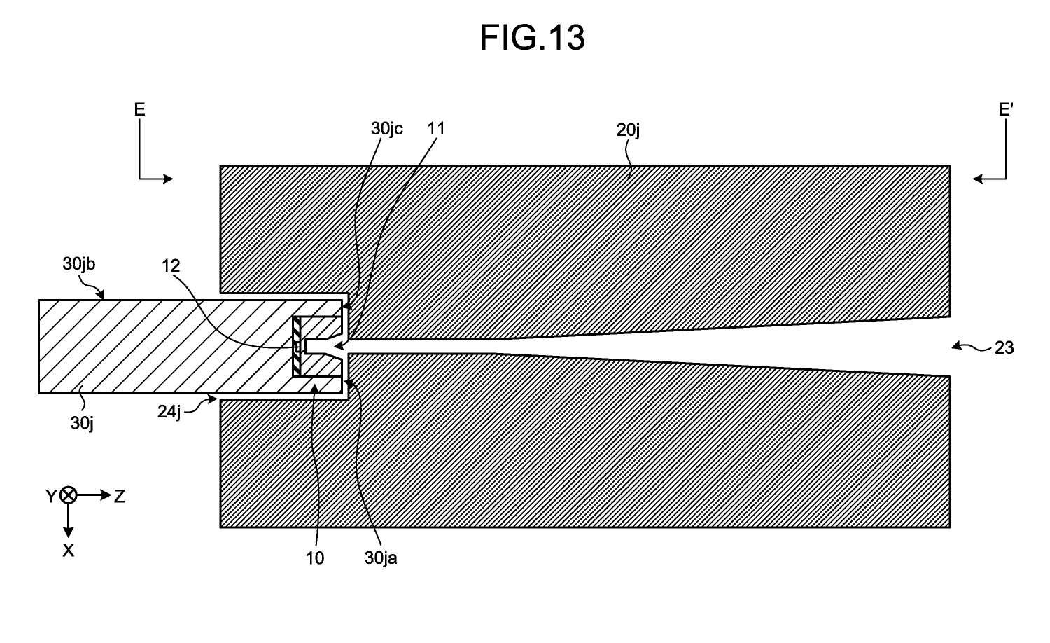

Specifically, an adaptor 20j in an optical coupling module 100j may be configured to have a recess 24j extending mainly along a YZ plane as shown in FIGS. 12 to 14. FIG. 12 is a perspective view showing the configuration of the optical coupling module 100j according to another modified example of the embodiment. FIG. 13 is a cross-sectional view showing the configuration of the optical coupling module 100j according to the modified example of the embodiment and taken along line E-E′ of FIG. 12. FIG. 14 is a cross-sectional view showing the configuration of the optical coupling module 100j according to the modified example of the embodiment and taken along line F-F′ of FIG. 12.

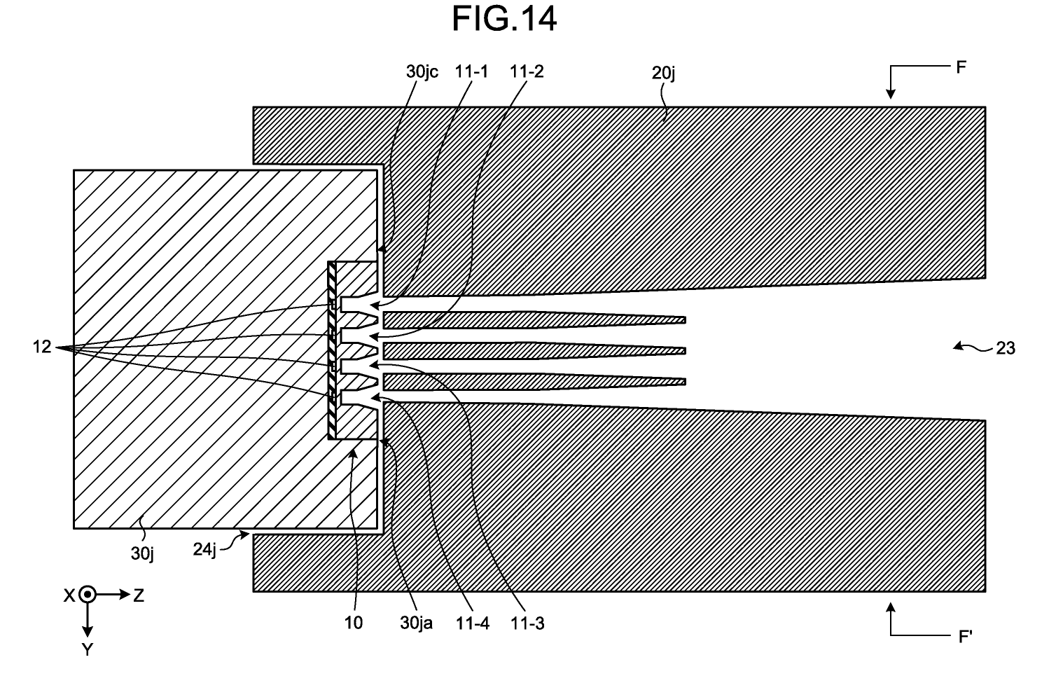

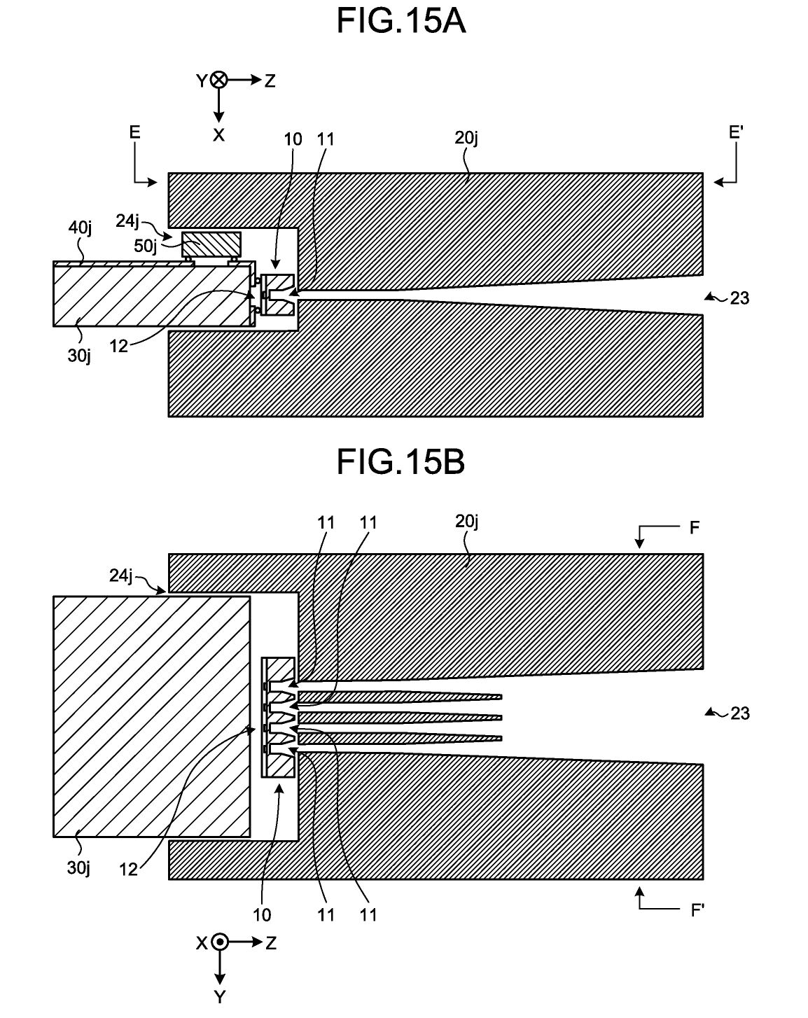

Specifically, the optical device 10 may be mounted in a substrate 30j by fitting the optical device 10 into an opening 30ja on an end face 30jc side of the substrate 30j (see FIGS. 13, 14) or by mounting the optical device 10 on the end face 30jc of the substrate 30j (see FIGS. 15A and 15B).

The adaptor 20j is substantially in a rectangular parallelepiped shape. The substrate 30j is accommodated in the recess 24j, and its principal surface 30jb extends along a YZ plane. The adaptor 20j covers the optical device 10 while the optical device 10 and the substrate 30j are accommodated in the recess 24j. A guide hole 23j is placed to be in communication with the optical device 10 while the optical device 10 and the substrate 30j are accommodated in the recess 24j. Thus, the guide hole 23 and the vias 11 can be easily aligned with each other.

The guide hole 23 is placed in a position corresponding to the plurality of optical elements 12-1 to 12-4 on the substrate 13 (see FIG. 1). The center axis CA23 of the guide hole 23 extends along a direction substantially parallel to the principal surface 30jb of the substrate 30j, that is, the Z direction to run through a point near the center CG12 of the optical element 12-1.

In this case, the assembly of the optical coupling module 100j may be the assembly as illustrated in FIGS. 15A and 15B. FIGS. 15A and 15B are diagrams illustrating the assembly of the optical coupling module 100j. FIG. 15A is a cross-sectional view corresponding to the cross-section taken along line E-E′ of FIG. 12, and FIG. 15B is a cross-sectional view corresponding to the cross-section taken along line F-F′ of FIG. 12.

In the assembly shown in FIGS. 15A and 15B, the optical coupling module 100j further has an interconnection 40j and an IC 50j. The interconnection 40j electrically connects the optical element 12 of the optical device 10 and the IC 50j. For example, the substrate 30j is a multi-layer printed wiring board and can be 2.0 mm thick. The IC 50j can include, e.g., a RAID controller. The interconnection 40j can be formed of material consisting mainly of, e.g., Cu.

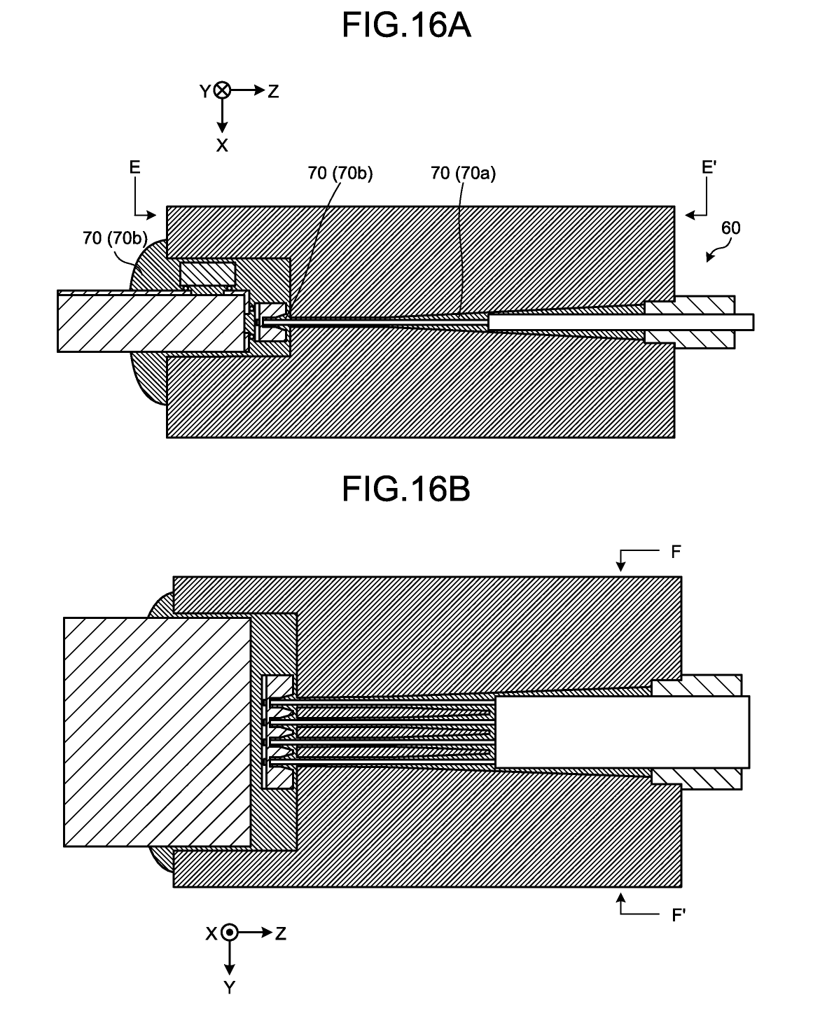

The same method as in the embodiment may be used for the method of mounting the optical fiber 60. That is, as shown in FIGS. 16A and 16B, the adhesive 70 is supplied with use of a dispenser needle (not shown) to the inside of the recess 24j in the optical coupling module 100j (see FIG. 15A) to coat with the adhesive 70. The substrate 30j in which the optical device 10 is mounted is inserted into the recess 24j. Then the adhesive 70 is supplied with use of the dispenser needle (not shown) to the inside of the guide hole 23 and the insides of the vias 11 to coat with the adhesive 70. At this time, the adhesive 70b may be supplied with the dispenser needle to the insides of the vias 11, and the adhesive 70a may be supplied with the dispenser needle into the guide hole 23. Then, the optical fiber 60 is inserted, and the adhesive 70 is hardened.

Or first the adaptor 20 is fixed to the optical fiber 60 by the adhesive 70, and a member in which the adaptor 20 and the optical fiber 60 are integrated may be aligned with, attached to, and fixed to the optical elements 12 (vias 11). FIGS. 16A and 16B are diagrams illustrating the assembly of the optical coupling module 100j. FIG. 16A is a cross-sectional view corresponding to the cross-section taken along line E-E′ of FIG. 12, and FIG. 16B is a cross-sectional view corresponding to the cross-section taken along line F-F′ of FIG. 12. Thus, optical coupling between the core lines 61 of the optical fiber 60 and the optical elements 12 of the optical device 10 can be easily realized.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An optical coupling module comprising:
an optical device; and
an adaptor attached to the optical device,
wherein the optical device has:
an optical element placed on a first principal surface of a substrate; and
a via placed in the substrate at a position corresponding to the optical element, the via having a first opening in a second principal surface of the substrate opposite to the first principal surface, the via not reaching the first principal surface, and
wherein the adaptor has a guide hole having a second opening in a third principal surface of the adaptor opposite the second principal surface, the second opening corresponding to the first opening, the guide hole having a third opening in a fourth principal surface of the adaptor.

2. The optical coupling module according to claim 1, further comprising an optical fiber extending through the guide hole to near a bottom of the via.

3. The optical coupling module according to claim 2, wherein
the optical fiber has a core line, and maximum opening width of the first opening corresponds to a width of the core line.

4. The optical coupling module according to claim 2, further comprising a buffer member placed between the adaptor and the optical fiber in the third opening.

5. The optical coupling module according to claim 1, wherein
maximum opening width of the third opening is greater than maximum opening width of the second opening.

6. The optical coupling module according to claim 1, wherein
maximum opening width of the second opening is smaller than maximum opening width of the first opening.

7. The optical coupling module according to claim 6, wherein
a main part of the second opening is within the first opening when seen through in a direction perpendicular to the first principal surface.

8. The optical coupling module according to claim 1, wherein
the via has a bottom on the first principal surface side, and maximum opening width of the first opening is greater than maximum width of the bottom.

9. The optical coupling module according to claim 1, wherein
the optical device has a plurality of the vias,
the guide hole in the adaptor has a plurality of the second openings corresponding to the first openings of the plurality of vias in the third principal surface, and
the third opening contains the plurality of second openings when seen through in a direction substantially perpendicular to the fourth principal surface.

10. The optical coupling module according to claim 9, further comprising an optical fiber extending through the guide hole to near a bottom of the via,
wherein the optical fiber has a plurality of core lines,
the guide hole in the adaptor has the plurality of second openings corresponding to the plurality of core lines, and
the third opening contains the plurality of second openings when seen through in a direction substantially perpendicular to the fourth principal surface.

11. The optical coupling module according to claim 10, wherein
the optical fiber further has a covering member,
a major part of the core line is covered by the covering member, and the top thereof is not covered by the covering member, and
the guide hole in the adaptor has stopper structures between the second openings and the third opening, which correspond to the covering member.

12. The optical coupling module according to claim 11, wherein
the stopper structures are provided such that the core line protrudes from the third principal surface into the optical device side over a length corresponding to the depth of the via while the covering member abuts the stopper structures.

13. The optical coupling module according to claim 1, wherein
maximum width of the adaptor is greater than maximum width of the optical device.

14. The optical coupling module according to claim 1, wherein
the adaptor has a recess to accommodate the optical device.

15. The optical coupling module according to claim 14, wherein
the guide hole in the adaptor is placed to be in communication with the via of the optical device while the optical device is accommodated in the recess.

16. The optical coupling module according to claim 14, wherein
the third principal surface of the adaptor is an inner side surface of the recess, and a gap is provided between the first principal surface of the optical device and the third principal surface of the recess while the optical device is accommodated in the recess.

17. The optical coupling module according to claim 14, wherein
the recess extends in a direction along the first principal surface.

18. The optical coupling module according to claim 14, wherein
the recess extends in a direction substantially perpendicular to the first principal surface.

19. The optical coupling module according to claim 1, wherein
the third principal surface of the adaptor is an end face of the adaptor.

20. The optical coupling module according to claim 19, further comprising an optical fiber constituted by a member in which the adaptor and an optical fiber are integrated and having a core line,
wherein the core line of the optical fiber, the integrated member, protrudes outward through the second opening of the adaptor.
